(19) United States
(12) Patent Application Publication
(10) Pub. No.: US 2022/0366757 A1
(43) Pub. Date: Nov. 17, 2022

(54) APPARATUSES AND METHODS FOR CONTROLLING THE DISPLAY OF PRIZES AT A GAMING MACHINE

(71) Applicant: Everi Games, Inc., Austin, TX (US)

(72) Inventor: Scott Slomiany, Chicago, IL (US)

(73) Assignee: Everi Games, Inc., Austin, TX (US)

(21) Appl. No.: 17/693,575

(22) Filed: Mar. 14, 2022

Related U.S. Application Data
(60) Provisional application No. 63/186,894, filed on May 11, 2021.

(51) Int. Cl. G07F 17/32; G07F 17/34

(52) U.S. Cl. CPC G07F 17/3211; G07F 17/3244; G07F 17/34

(57) ABSTRACT

Controlling a gaming machine includes displaying a starting graphic that includes both one or more prize-contributing numerical values and one or more non-contributing numerical values. The non-contributing numerical values may precede, follow, or both precede and follow the respective prize-contributing numerical value. Once the starting graphic is displayed, each of the non-contributing numerical values is replaced with a respective non-numerical graphic to ultimately reveal at the gaming machine the one or more prize-contributing numerical values. A prize is then awarded which includes a prize value defined by either a combination of the prize-contributing numerical values where more than one prize-contributing numerical value is included in the starting graphic or by the sole prize-contributing numerical value where only one prize-contributing numerical value is included in the starting graphic.

### CROSS-REFERENCE TO RELATED APPLICATION

Applicant claims the benefit, under 35 U.S.C. § 119(e), of U.S. Provisional Patent Application No. 63/186,894 filed May 11, 2021, and entitled “Apparatuses and Methods for Controlling the Display of Prizes at a Gaming Machine.” The entire content of this provisional application is incorporated herein by this reference.

### TECHNICAL FIELD OF THE INVENTION

The invention relates to gaming machines and the control and operation of gaming machines, in particular, the control of gaming machines to display prizes.

### BACKGROUND OF THE INVENTION

Traditional gaming machines include both mechanical reel and video reel-type gaming machines, video poker gaming machines, and numerous other types of gaming machines that are available for play at casinos or other gaming establishments. Such gaming machines operate to ultimately display a game result for a given activation, and this game result may or may not be associated with a prize to be awarded to the player for the given activation. Various types of game operation and various types of interesting graphics and graphic effects, together with sound effects, have been developed in an effort to provide more entertainment value for players and thereby help maintain the players' interest. There is an ongoing need in the gaming industry to provide gaming machines and gaming machine operation and control methods that maintain player interest and provide high entertainment value to encourage play.

### SUMMARY OF THE INVENTION

One object of the invention to provide gaming machines and gaming machine control methods that display at least a portion of the result for a given activation in a form in which the player may readily understand the result without referring to pay tables. Another object of the invention is to provide gaming machines and gaming machine control methods that provide high entertainment value by building player anticipation.

Methods of controlling a gaming machine according to a first aspect of the invention includes displaying a starting graphic that includes both one or more prize-contributing numerical values and one or more non-contributing numerical values. These non-contributing numerical values may precede, follow, or both precede and follow the respective prize-contributing numerical value. The methods further include displaying a replacement of each of the non-contributing numerical values with a respective non-numerical graphic to reveal at the display system the one or more prize-contributing numerical values. The methods include awarding a prize including a prize value defined by either a combination of the prize-contributing numerical values where more than one prize-contributing numerical value is included in the starting graphic or by the sole prize-contributing numerical value where only one prize-contributing numerical value is included in the starting graphic.

Implementations of methods according to this first aspect of the invention may include numerous variations in the manner in which multiple prize-contributing numerical values may be combined to produce the prize to be awarded, the rates and sequences in which non-contributing numerical values are replaced, other aspects of how the non-contributing numerical values are replaced, and the nature of the non-numerical graphics that may be employed. These variations will be described below in connection with descriptions of the illustrated embodiments.

Additional aspects of the invention include gaming machines and program products for implementing methods according to the first aspect of the invention and according to the variations described below.

These and other advantages and features of the invention will be apparent from the following description of representative embodiments, considered along with the accompanying drawings.

### BRIEF DESCRIPTION OF THE DRAWINGS

FIG. 1 is an isometric view of a gaming machine that may be used for implementations of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is a flow chart showing a process in accordance with an example embodiment of the present invention.

FIG. 5 is a representation of a graphic presentation in an implementation of the present invention at a point in time prior to the display of the starting graphic.

FIG. 6 is a representation of a graphic presentation comprising a starting graphic produced after the presentation shown in FIG. 5.

FIG. 7 is a representation of a graphic presentation produced in the implementation shown in FIG. 6, but at a point in time after that shown in FIG. 6.

FIG. 8 is a representation of a graphic presentation produced in the implementation shown in FIG. 6, but at a point in time after that shown in FIG. 7.

FIG. 9 is a representation of a graphic presentation produced in the implementation shown in FIG. 6, but at a point in time after that shown in FIG. 8.

FIG. 10 is a representation of a graphic presentation produced in the implementation shown in FIG. 6, but at a point in time after that shown in FIG. 9.

FIG. 11 is a representation of a graphic presentation produced in the implementation shown in FIG. 6, but at a point in time after that shown in FIG. 10 and comprising a final graphic presentation in the implementation after the prize has been awarded.

FIG. 12 is a representation of a graphic presentation produced in another implementation of the present invention.

FIG. 13 is a representation of a graphic presentation comprising a starting graphic produced after the presentation shown in FIG. 12.

FIG. 14 is block diagram showing software data structures which may be employed in an implementation of the present invention.

### DESCRIPTION OF REPRESENTATIVE EMBODIMENTS

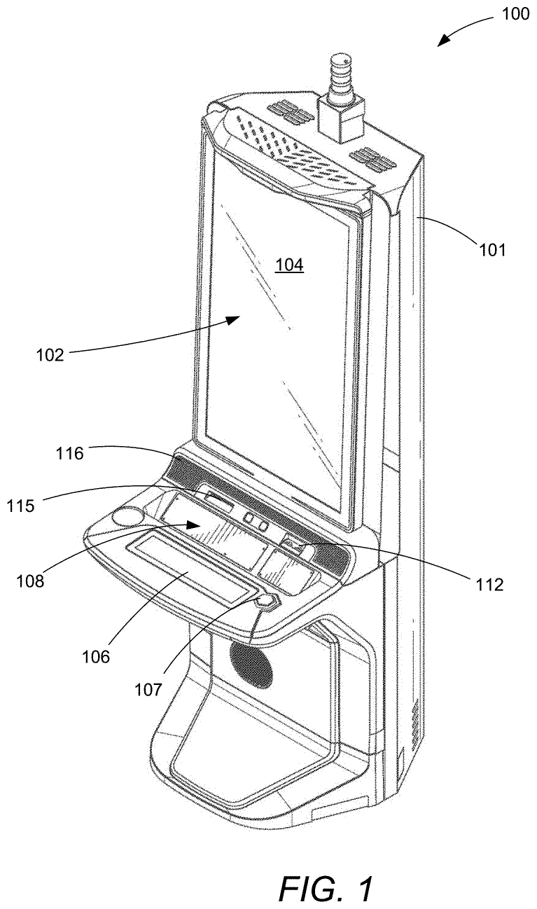

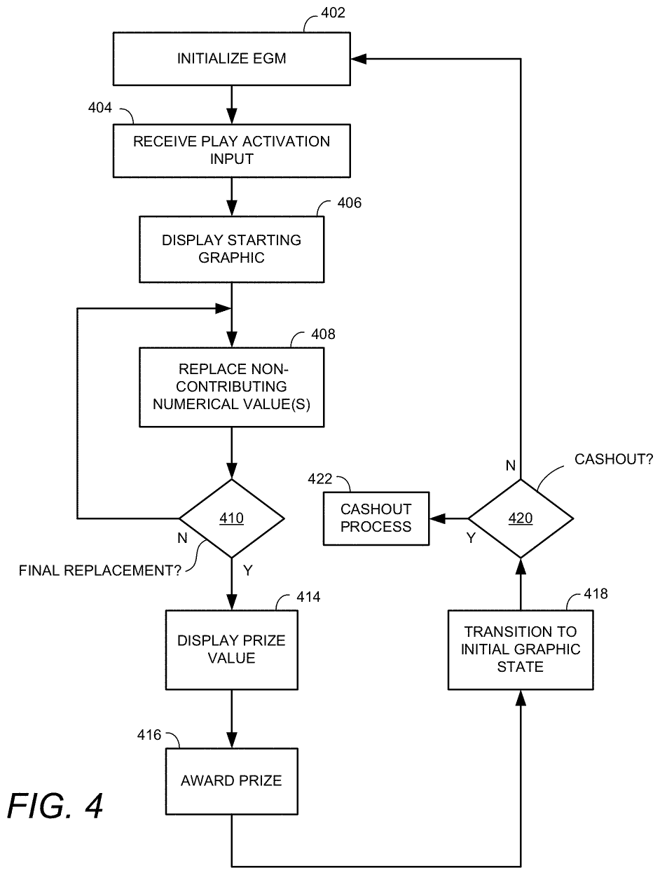

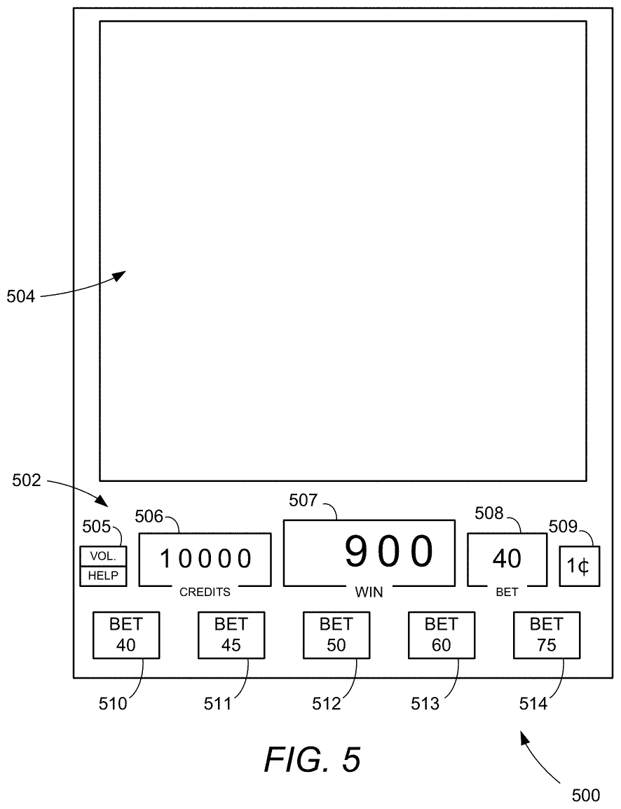

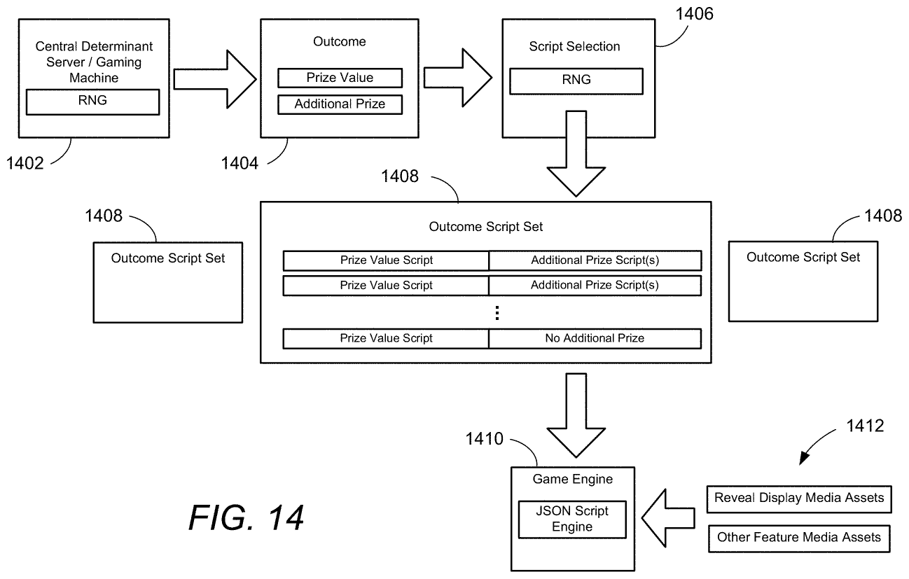

FIGS. 1-3 will be used to describe gaming machines and gaming networks in which aspects of the present invention may be implemented. FIG. 4 will be used to describe example methods of controlling a gaming machine according to various implementations of the present invention. FIGS. 5-13 will be referenced below to describe example implementations of prize display processes and systems in accordance with the present invention. FIG. 14 will be referenced below to describe certain software and data structures that may be employed in implementations of the invention.

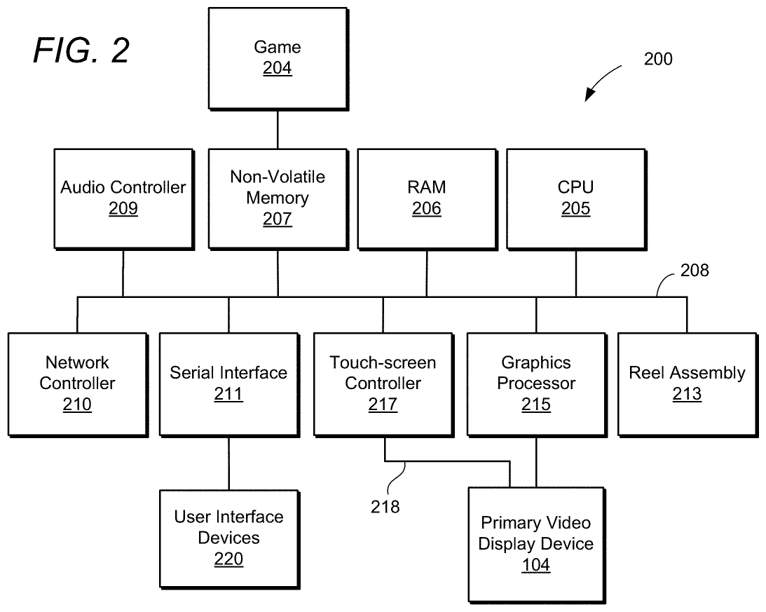

Referring to FIG. 1, gaming machine 100 includes a cabinet 101 having a front side generally shown at reference numeral 102. A primary video display device 104 is mounted in a central and upper portion of the front side 102, and a touch-screen button panel 106 is positioned below the primary video display device. Gaming machine 100 may include additional smaller auxiliary display devices (not shown) and/or other devices in the area shown generally at 108. It should also be noted that each display device referenced herein may include any suitable display device including a cathode ray tube, liquid crystal display, plasma display, LED display, or any other type of display device currently known or that may be developed in the future. One or more of these video display devices, and especially primary video display device 104, may be used to display graphics associated with a prize presentation in accordance with aspects of the present invention either as a base game or bonus game. As will be described further below in connection with FIG. 2 and elsewhere, it is also possible for gaming machines within the scope of the present invention to include mechanical elements such as mechanical reels. Generally, the display device or display devices of the gaming machine, through which prize presentations may be shown in accordance with the present invention may be described in this disclosure and the accompanying claims as a “display system” regardless of whether the gaming machine in question includes physical reels or one or more video display devices showing graphic elements such as reel simulations, or combinations of physical and simulated reels, or no physical or simulated reels. The term “display” when not used to qualify a term such as “device,” “apparatus,” or “system,” for example, will be used in this disclosure and accompanying claims to refer to an arrangement of one or more graphic elements shown by a display device or to the act of displaying such graphic elements by a display device unless explicitly indicated otherwise.

The gaming machine 100 illustrated for purposes of example in FIG. 1 also includes a mechanical control button 107 mounted adjacent to touch-screen button panel 106. This control button 107 may allow a player to make a play input to start a play in a game conducted through gaming machine 100, while virtual buttons included (but not shown in this view) on button panel 106 or other physical buttons or controls (not shown) may allow a player to select a bet level for a game implemented at the gaming machine, select a type of game or game feature, and make other inputs at the gaming machine preparatory to or during the play of a game at the gaming machine. Touch-screen button panel 106 may also be used to allow the player to control a cursor that may be displayed on another display device. Other forms of gaming machines through which the invention may be implemented may include switches, joysticks, or other mechanical input devices in addition to the virtual buttons and other controls implemented on touch-screen button panel 106. Additionally, primary video display device 104 in gaming machine 100 provides a convenient display device for implementing touch screen controls in addition to or in lieu of controls included on touch-screen button panel 106 or mechanical controls. The player interface devices that receive player inputs in the course of a game played through the gaming machine, such as controls to select a wager amount for a given play, controls to enter a play input to actually start a given play in the game, or controls to allow a player to make other player inputs in a game controlled according to the present invention, may be referred to generally as a “player input system.”

It will be appreciated that gaming machines may also include a number of other player interface devices in addition to devices that are considered player controls for use in entering inputs in the course of a particular game. Gaming machine 100 also includes a currency/voucher acceptor having an input ramp 112, a voucher/receipt printer having a voucher/receipt output 115, and a player card reader (not shown in the view of FIG. 1). Numerous other types of player interface devices may be included in gaming machines that may be used to implement embodiments of the present invention.

Gaming machine 100 may also include a sound system to provide an audio output to enhance the user's playing experience. For example, illustrated gaming machine 100 includes speakers (not shown) behind grille 116 that may be driven by a suitable audio amplifier (not shown) to provide a desired audio output at the gaming machine.

FIG. 2 shows a logical and hardware block diagram 200 of gaming machine 100 that includes a processor (CPU) 205 along with random access memory (RAM) 206 and nonvolatile memory or storage device 207. All of these devices are connected on a system bus 208 with an audio controller device 209, a network controller 210, and a serial interface 211. A graphics processor 215 is also connected on bus 208 and is connected to drive primary video display device 104 (the display device 104 being mounted on cabinet 101 as shown in FIG. 1). As shown in FIG. 2, gaming machine 100 also includes a touch screen controller 217 connected to system bus 208. Touch screen controller 217 is also connected via signal path 218 to receive signals from a touch screen element associated with primary video display device 104 or touch-screen button panel 106 or both. It will be appreciated that the touch screen element itself typically comprises a thin film that is secured over the display surface of the respective display device such as the display device of touch-screen button panel 106 in FIG. 1. The touch-screen element itself is not illustrated or referenced separately in the figures. The present invention is not limited to any particular touch-screen technology.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured for use in a wagering game environment. These elements may be mounted on (or connected to) a motherboard and housed in a personal computer housing that itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch-screen controller such as touch screen controller 217, the touch-screen controller may not be connected on system bus 208, but instead include a serial communications line to serial interface 211, which may be a USB controller for example. It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus or bus configured according to some other expansion bus standard. System bus 208 is shown in FIG. 2 merely to indicate that the various components are connected in some fashion for communication with CPU 205 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 205 or graphics processor such as 215 at the gaming machine and may instead rely on one or more remote processors. Thus unless specifically stated otherwise, the designation “gaming machine” is used in this disclosure and the accompanying claims to designate a system of devices that operate together to provide the indicated functions. A “gaming machine” may include a gaming machine such as gaming machine 100 shown in FIGS. 1 and 2, which is itself a system of various components, and may also include one or more components remote from a gaming machine cabinet (that is, cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as identifying prizes for a given play, controlling the display system, and performing other operations described below in connection with the example process shown in FIG. 4).

It will also be appreciated that graphics processors are also commonly a part of modern computer systems. Although separate graphics processor 215 is shown for controlling primary video display device 104, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display devices or other types of display devices. While the large display device 104 is particularly suited for showing displays in accordance with some implementations in accordance with aspects of the present invention, the display device area may be arranged differently than the portrait orientation shown or divided across multiple discrete display devices within the scope of the present invention.

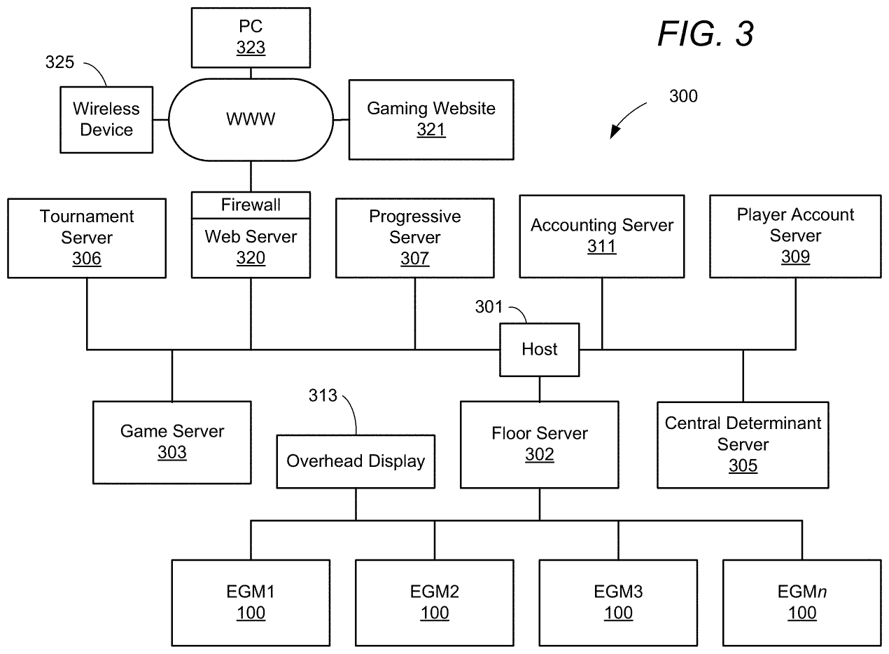

In the illustrated gaming machine 100, CPU 205 executes software, that is, program code, that ultimately controls the entire gaming machine including the receipt of player inputs and the presentation of the graphics or information displayed according to the invention through the display devices 104 and 106 associated with the gaming machine. In particular, CPU 205 may execute starting graphic program code, replacement program code, and prize assignment program code as set out in accompanying claims and described further below in connection with FIGS. 4 and 14 as well as the example graphic displays. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software (program code) prior to loading into random access memory 206 for execution, or for programs not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices to perform the various processing steps for implementing the invention. Unlike general purpose processing devices such as CPU 205, which may comprise an Intel® or AMD® processor for example, these special purpose processing devices may not employ operational program code to direct the various processing steps.

The example gaming machine 100 is shown in FIG. 2 as including user interface devices 220 (part of a player input system) connected to serial interface 211. These user interface devices may include various player input devices such as mechanical buttons, virtual buttons shown on touch-screen button panel 106 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine in accordance with aspects of the present invention may also include mechanical reels. For example, a number of sets of mechanical reels may replace the primary display device 104, or at least part of that display device. Alternatively, mechanical reels may be included in the gaming machine behind a light-transmissive video display panel. Mechanical reels may also include one or more video display devices in place of a static reel symbol strip and thus be capable of conducting single-symbol reel spin simulations for one or more game symbol locations. In any case, the mechanical reels represent a display device for displaying various game symbols in the course of controlling the gaming machine. Although the invention is not limited to any particular mechanical reel arrangement or control system, mechanical reels may be controlled conveniently through serial communications that provide instructions for a respective stepper motor for each reel. Thus some embodiments of the present invention employing mechanical reels may use a serial interface device such as serial interface 211 to control communications with the reel assembly, and may not include a direct bus interconnection as indicated by FIG. 2. Details of a mechanical reel arrangement and various accent lighting arrangements that may be associated with mechanical reels are not shown in the present figures so as to avoid obscuring the present invention in unnecessary detail.

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead display devices 313 may be operatively connected so that the overhead display device or display devices may mirror or replay the content of one or more displays of gaming machines 100. For example, the primary display content for a given gaming machine 100 may be transmitted through network controller 210 to a controller associated with the overhead display device(s) 313. In the event gaming machines 100 have cameras installed, the respective player's video images may be displayed on overhead display device 313 along with the content of the player's gaming machine display device.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the outcome information to networked gaming machines 100 that present the outcomes to players.

Tournament server 306 may be included in the system for controlling or coordinating tournament functions. These functions may include maintaining tournament player scores and ranking during the course of tournament play and communicating this information to the various gaming machines 100 participating in the tournament. Tournament server 306 may also function to enroll players in tournaments, schedule tournaments, and maintain the time remaining in the various tournaments.

Progressive server 307 may maintain progressive pools for progressive games that may be available through the various gaming machines 100. In some implementations, progressive server 307 may simply receive communications indicating contribution amounts determined by processes executing at the various gaming machines 100 or elsewhere in the gaming network. Alternatively, progressive server 307 may perform processes to determine the contribution amounts for incrementing the various progressive pools that may be maintained. Progressive server 307 may also periodically communicate current pool values back to the various gaming machines 100 and may participate in communicating awarded progressive prize amounts to the gaming machines and making adjustments to the progressive prize pools accordingly. In some implementations, progressive server 307 may also determine or participate in determining when a progressive prize triggering event occurs.

Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 that may be hosted through web server 320 and may be accessible by players via the Internet. One or more games may be displayed as described herein and played by a player through a personal computer 323 or handheld wireless device 325 (for example, an Android® operating system smart phone, Apple® iPhone® smart phone, personal digital assistant (PDA), iPad® or other tablet computer, etc.). To enter website 321, a player may log in with a username that may, for example, be associated with the player's account information stored on player account server 309. Once logged in to website 321 the player may play various games on the website, including games according to the invention. Also, website 321 may allow the player to make various personalizing selections and save the information so it is available for use during the player's next gaming session at a casino establishment having the gaming machines 100.

It will be appreciated that gaming network 300 illustrated in FIG. 3 is provided merely as an example of a gaming network which may facilitate prize presentations according to aspects of the present invention and is not intended to be limiting in any way. Gaming machines controlled according to aspects of the present invention are not limited to use with gaming networks such as network 300.

FIG. 4 shows an example process of controlling a gaming machine to provide prize presentations or displays in accordance with aspects of the present invention. The illustrated method includes initializing the EGM (such as gaming machine/EGM 100 shown in FIGS. 1 and 3) at process block 402 and then receiving a play activation input as shown at process block 404. Initializing the gaming machine as indicated at process block 402 in FIG. 4 comprises any process needed in the given implementation and at a given instance of the process shown in the figure to place the gaming machine in a state for receiving the play activation input. The play activation input indicated at process block 404 may be received in any suitable fashion, such as, for example, through a player actuated control such as a “Play” button or lever. Each game play activation input may be associated with a wager selected or entered by the player through a suitable control included in the player input system as part of the initializing process shown at process block 402. The wager may be a monetary value, a credit value that may equate to a monetary value, or point value that does not equate to any monetary value. Other implementations, including implementations through gaming machines other than casino-style gaming machines such as that shown in FIG. 1, may not require a wager for initializing the gaming machine as shown at process block 402 for receiving a game play input as shown at process block 404. In still further variations within the scope of the present invention, the receipt of a wager input at the gaming machine may itself represent a play activation input while other initializing steps or inputs may be required as indicated at process block 402.

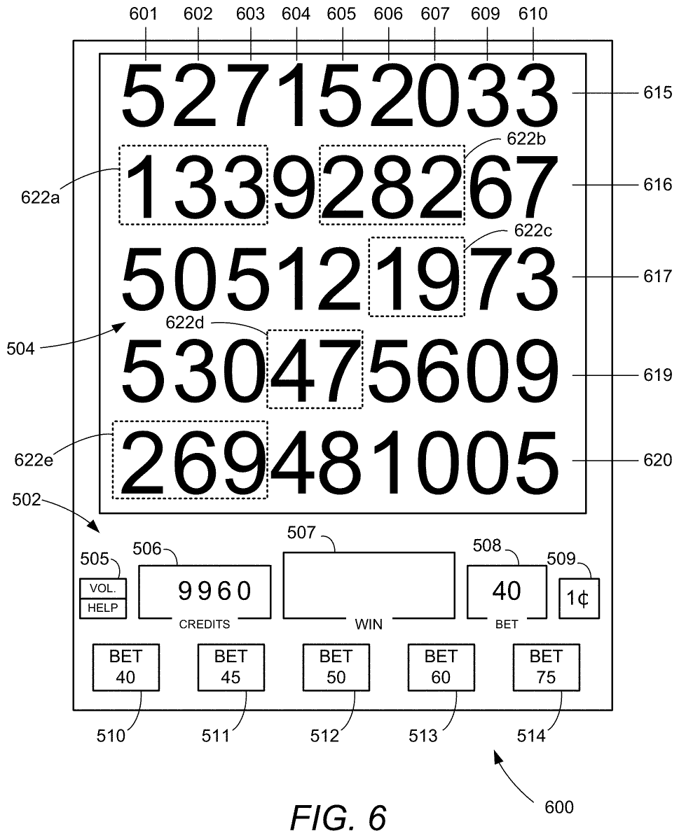

In response to the play activation input, the process includes causing the display system associated with the gaming machine to display a starting graphic as shown at process block 406. As will be described in the specific example shown in FIG. 6, this display of the starting graphic includes controlling the gaming machine display system to display populating locations in an array of game symbol locations with one or more prize-contributing numerical values. For at least one of the one or more prize-contributing numerical values, displaying the starting graphic also includes displaying one or more non-contributing numerical values preceding, following, or, in the case of multiple non-contributing numerical values, both preceding and following the respective prize-contributing numerical value.

After displaying the starting graphic, the method illustrated in FIG. 4 includes causing the display system to display a replacement of a respective non-contributing numerical value with a respective non-numerical graphic as shown at process block 408. If there are further non-contributing numerical values remaining from the starting graphic as indicated by the negative outcome at decision box 410 in FIG. 4, the process returns to replace another of the non-contributing numerical values shown in the starting graphic. This process continues in the example of FIG. 4 until all of the non-contributing numerical values are replaced with a respective non-numerical graphic to reveal at the display system the one or more prize-contributing numerical values. That is, the one or more prize-contributing numerical values are revealed by remaining in the display after all of the non-contributing numerical values have been replaced. Where there are multiple prize-contributing numerical values, these values combine to produce a prize value displayed as indicated at process block 414. Otherwise, the sole prize-contributing value if there is only one in the starting graphic represents the prize value displayed at block 414. In any event, this prize value is included in a prize awarded as indicated at process block 416 for the play activation input received at 404. This awarding step may include incrementing the player's account or a credit meter displayed at the gaming machine by the prize value and any other value to be awarded for the given play activation input.

Once the prize is awarded as indicated at process block 416, the process continues on to transition the display system as shown at 418 back to an initial graphic state for another activation input at 404 and initialization (if necessary) at 402 in FIG. 4. If the player makes an input at the gaming machine indicating a desire to cash out at the gaming machine as indicated by an affirmative outcome at decision box 420, a cashout process is then conducted as indicated at 422 rather than returning for another play activation input.

In the process flow indicated in FIG. 4, displaying the starting graphic as indicated at process at block 406 may be conducted under the control of starting graphic program code executed at a processing system associated with a gaming machine such as gaming machine 100 shown in FIG. 1. The replacement of non-contributing numerical values as indicated by the loop through 408 and 410 in FIG. 4, and the resultant display of the prize value as indicated at process block 414 may be conducted under the control of replacement program code executed at the processing system. Any award of prizes for the given activation of the gaming machine as indicated at 416 in FIG. 4 may be conducted under the control of prize assignment program code executed by the processing system.

The example process shown in FIG. 4 assumes that the prize presentation arrangement according to the present invention is a standalone process, separate from any other game presentation. It will be appreciated, however, that prize presentation according to the present invention is not limited to a standalone process. Rather, the process steps 406-414 shown in FIG. 4 may be part of an overall game process that may include additional features or parts. For example, the process steps 406-414 may comprise a bonus game or feature that is reached after the conduct of a base game portion or another bonus feature. Alternatively, process steps 406-414 may represent a base game portion after which additional portions of an overall game are presented and an overall prize awarded as indicated at process block 416.

FIGS. 5-11 will now be referenced to describe a series of displays produced in accordance with an embodiment of the present invention to ultimately reveal a prize value for an activation of a gaming machine. FIG. 5 shows a display 500 that may be produced on a display device such as display device 104 shown in FIG. 1 for gaming machine 100. Display 500 includes a player information section shown generally at 502, including a number of windows providing information to the player. Example play information section 502 includes a credit meter window 506 for displaying a credit value for the player at the given gaming machine, and a win meter window 507 for displaying the credit value of a win for a current activation of the gaming machine. Example display 500 shows a credit value of 10000 credits at credit meter window 506 and a win value 900 credits at win meter window 507, indicating a 900-credit win for the last activation of the gaming machine. Player information section 502 further includes a bet value window 508 in this case showing a bet of 40 credits for the last activation of the gaming machine, and a game denomination window 509 indicating a denomination of 1 cent per credit. Player controls 505 are also shown in display 500 and include a volume control by which the gaming machine volume may be adjusted, and a help button that may be invoked to access help information regarding game play. A series of bet buttons 510-514 are include at the bottom of display 500. It will be appreciated that controls 505 and bet buttons 510-514 are virtual buttons that may be invoked via a touch in a touch-screen implementation or by a cursor or other pointer device. Display 500 further includes a field shown generally at 504 that provides an area for displaying the prize-contributing numerical values and non-contributing numerical values in accordance with the present invention.

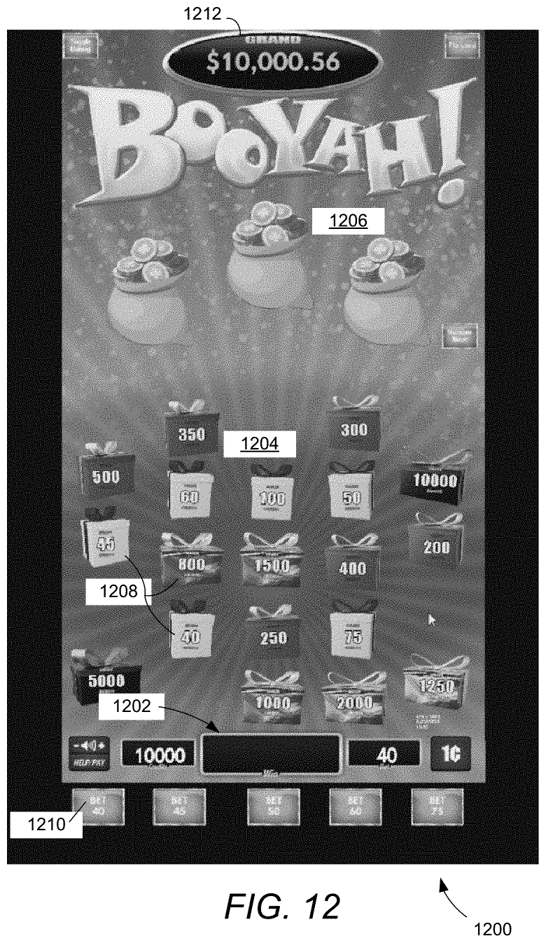

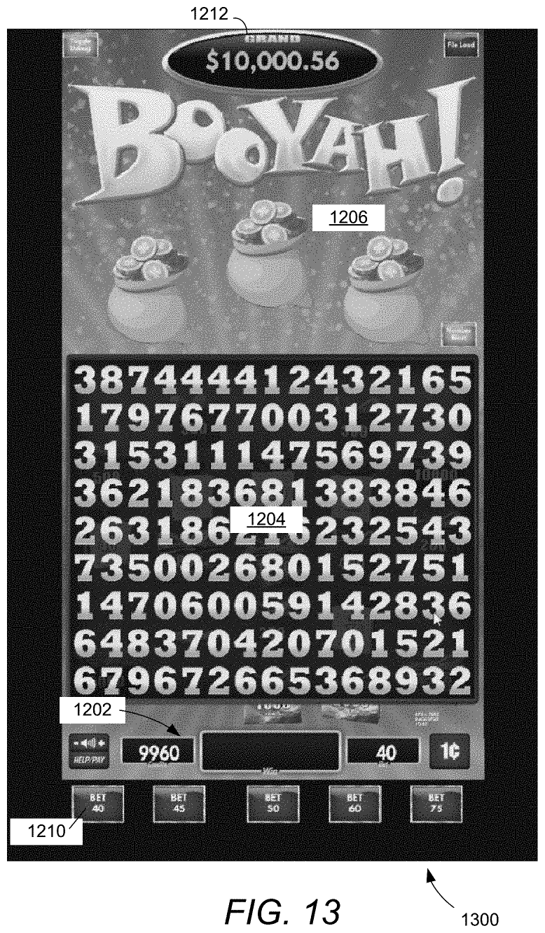

The state of the gaming machine indicated by display 500 is a state after completion of a previous activation of the gaming machine but before the activation of the gaming machine for a current play. Although field 504 is simply shown blank in this example, implementations of the invention may include various entertaining graphics in this field between plays, or game controls as will be described below in connection with the alternate example shown in FIGS. 12 and 13.

FIG. 6 shows a display 600 produced in accordance with the present invention after the point in time of display 500, namely, produced in response to an activation of the gaming machine by entering a 40-credit bet by invoking the bet control 510. The 40-credit bet level is shown in bet window 508 and the 40 credits have been deducted from the value in the credit meter window 506 leaving 9960 credits remaining available for play at the gaming machine. Display 600 also includes a starting graphic in field 504 comprising a number of numerical values made up of prize-contributing numerical values and non-contributing numerical values. In this particular example, the prize-contributing values are shown in dashed line boxes and comprise “133” at box 622a, “282” at box 622b, “19” at box 622c, “47” at box 622d, and “269” at box 622e. The remainder of the numbers shown in field 504 in FIG. 6 are non-contributing numerical values. It should be appreciated that the dashed boxes are not part of display 600 and are shown here only to allow the prize-contributing numerical values to be distinguished from the non-contributing numerical values. In an actual implementation, the prize-contributing numerical values are not called out in any way in the starting graphic and thus the prize value for the given activation of the gaming machine is not apparent to the player from the starting graphic.

In this example, the starting graphic includes a group of initial digit sets, each initial digit set including a respective number at each of a plurality of respective number locations in horizontal alignment and the initial digit sets together defining an initial digit field that comprises an array of numbers in columns 601-610 and rows 615-620. In the following description, a given number location in the array will be identified by column/row. For example, the number at 601/615 is “5” in FIG. 6 and the number at 607/619 is “6.” Any number of columns and rows may be included in a given implementation of the invention, and the invention is by no means limited to the 9-column, 5-row array shown in the example of FIG. 6. Also, although the prize-contributing numerical values are shown as being arranged in sets of horizontal number locations, other implementations may include prize-contributing numerical values in vertically or diagonally arranged number locations or combinations of these arrangements or any other arrangement of number locations.

From display 600 shown in FIG. 6, the invention includes causing the display system to display a replacement of each of the non-contributing numerical values with a respective non-numerical graphic to reveal at the display system the one or more prize-contributing numerical values. In other words, from the state of display 600, non-contributing numerical values are replaced with non-numerical values until only the prize-contributing numerical values remain. Where, as in the present example of FIGS. 5-11, there are multiple prize-contributing numerical values in the starting graphic, the prize value to be included in the prize awarded for the activation of the game comprises a combination of the multiple prize-contributing numerical values. Otherwise, the prize value to be included in the prize comprises the single prize-contributing numerical value.

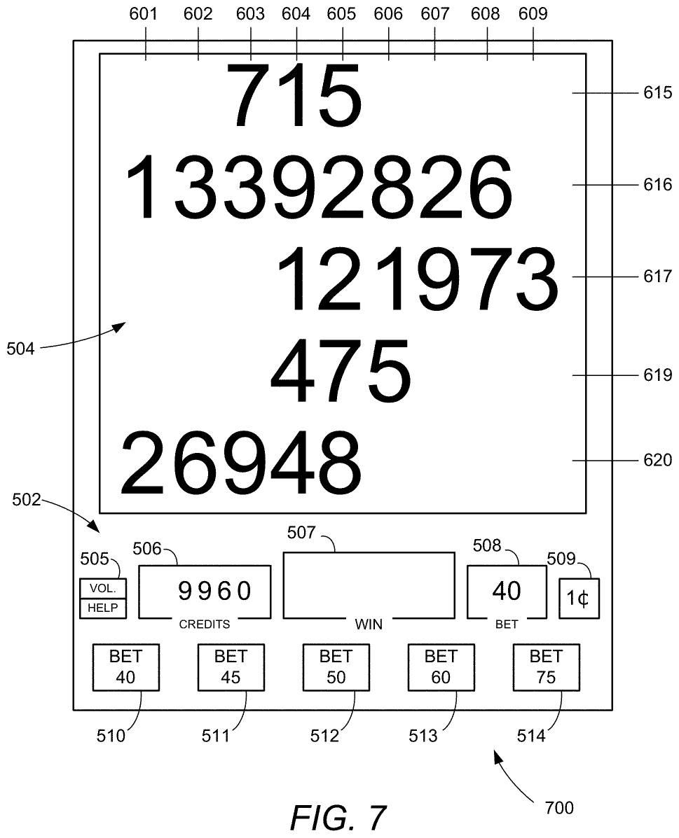

FIG. 7 shows a display 700 produced at a point in time in the process shown in FIG. 4 after some of the non-contributing numerical values have been replaced with a respective non-numerical graphic, in this case a blank space. In particular, display 700 shows a state in which twenty of the numerical values at number locations in the original array have been replaced with non-numerical graphics comprising blanks. The invention encompasses numerous variations in both the non-numerical graphic that may be shown in replacing a particular non-contributing numerical value, and in the manner in which the non-contributing numerical values are replaced. Generally, the invention encompasses any non-numerical graphic from a blank as shown in the present example to graphic elements that clearly have no numerical meaning unless specifically defined as such for the given implementation. Also, all of the numerical values shown in the starting graphic may be shown as instantaneously appearing at a given location or disappearing from a given location. Numerical values may alternatively gradually appear at a given location or gradually disappear from a given location. Each number location may comprise a location populated by a single simulated reel. The reels may spin and come to a stop to produce the starting graphic and may spin to a blank or other non-numerical graphic to show the replacement of a given non-contributing numerical value.

Any time a starting graphic includes three or more non-contributing numerical values, and especially a fairly large number of such values (32 non-contributing values in the example of FIGS. 5-11), displaying the replacement of the non-contributing numerical values may be performed at a rate that declines from an initial rate, either in a linear or non-linear fashion. Also, displaying the replacement of the non-contributing numerical values may include displaying the replacement of at least two of the non-contributing numerical values substantially simultaneously. Alternatively, only a single respective non-contributing numerical value may be replaced at each respective time in the replacement sequence, or for at least some of the replacement sequence. In any case, implementations may include causing the gaming machine to produce a non-contributing numerical replacement sound in coordination with the replacement of at least one of the non-contributing numerical values.

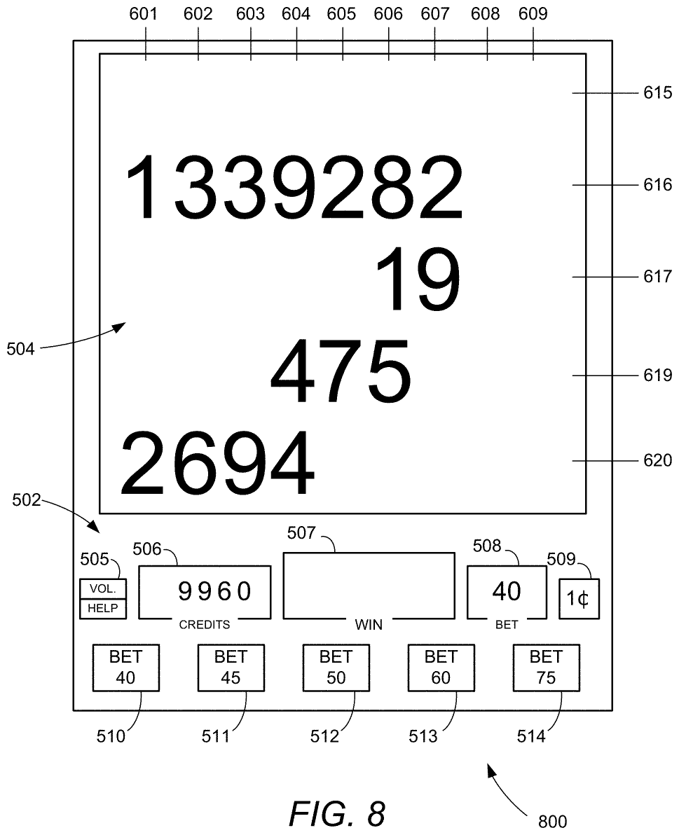

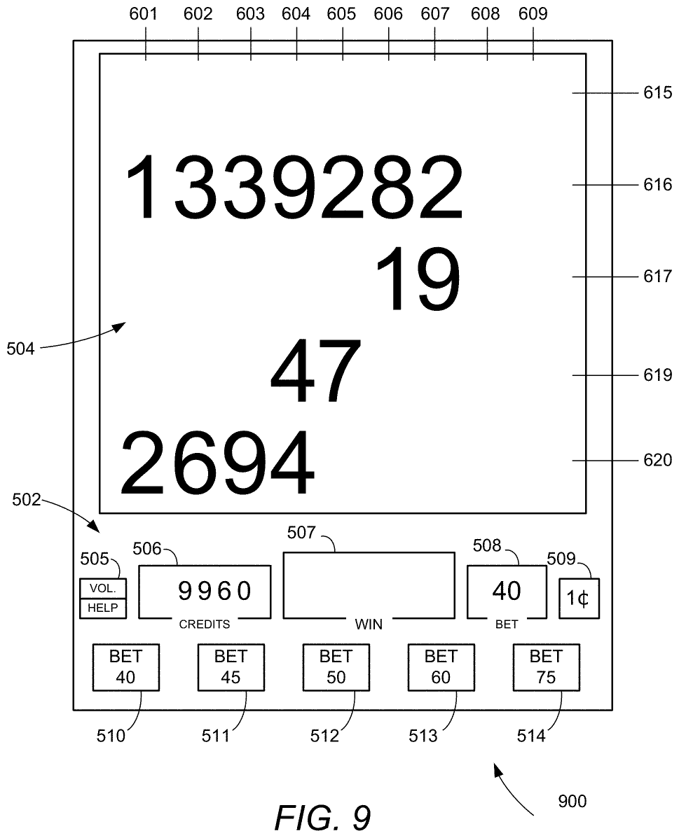

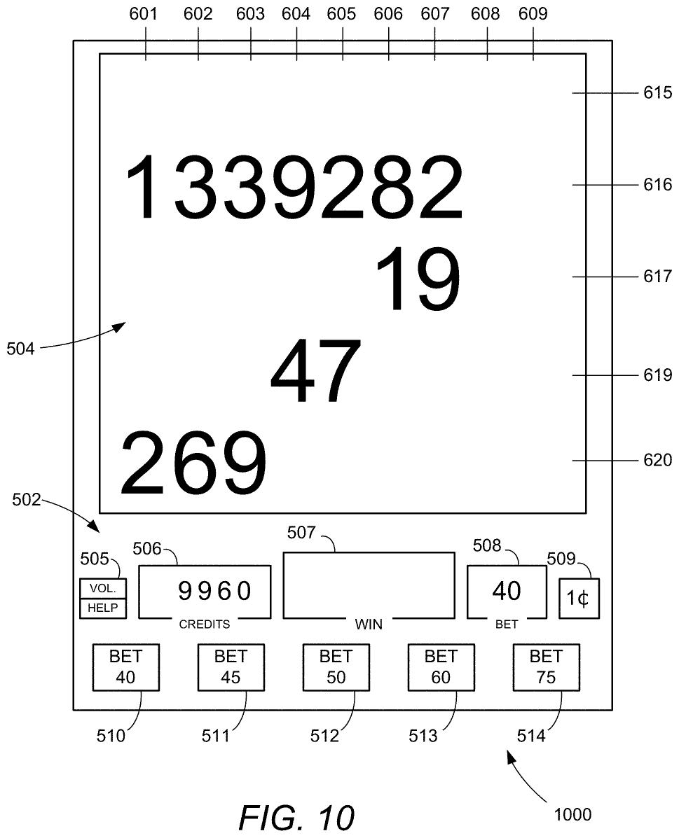

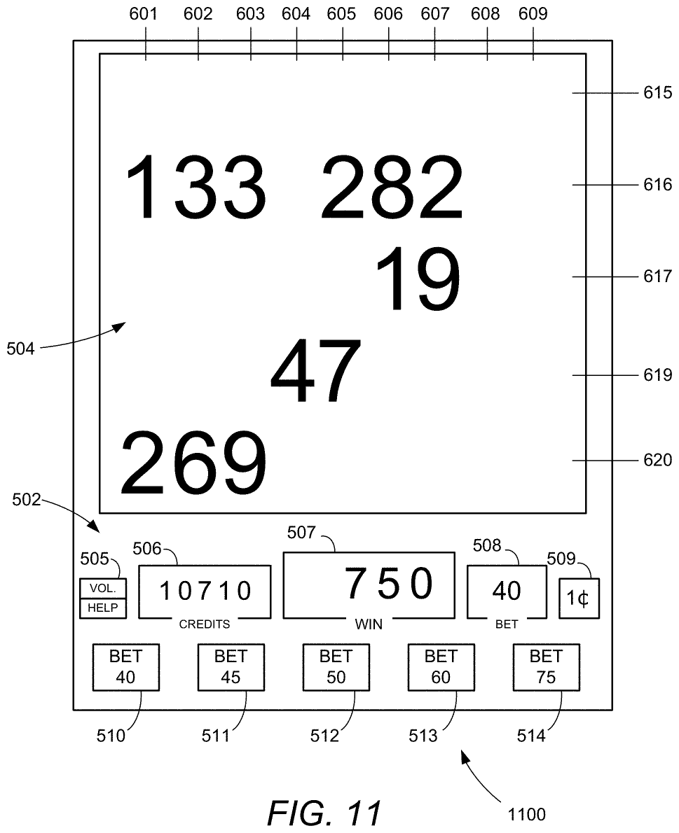

FIG. 8 shows a display 800 at a point in time in the loop through blocks 408 and 410 in the process of FIG. 4 at which nine more non-contributing numerical values have been each replaced by a non-numerical graphic comprising a blank relative to the state shown in FIG. 7. The sequence of FIGS. 9-11 each show a single non-contributing numerical value at a single number location in the array has been replaced by a blank relative to the previous state. Namely, FIG. 9 shows the value at 606/619, “5” has been replaced relative to FIG. 8, FIG. 10 shows the value at 604/620, “4” has been replaced relative to FIG. 9, and finally FIG. 11 shows the value at 604/616, “9” has been replaced relative to FIG. 10 to reveal the prize-contributing numerical values 133, 282, 19, 47, and 269. Thus, in this illustrated embodiment the replacement of each non-contributing numerical value with the respective non-numerical graphic includes causing the display system to display the replacement of the respective number at the respective number location in the respective initial digit set shown in FIG. 6 with a respective non-numerical location graphic such that after each non-contributing numerical value is replaced, the display system displays one or more final digit sets. Each final digit set defines a respective one of the prize-contributing numerical values and comprises a sequence of one or more of the number locations each containing the respective number included at that number location in the initial digit field shown in FIG. 6.

It should be noted that in the example of FIGS. 5-11, the final few non-contributing numerical values are replaced at locations adjacent to a final digit set defining one of the prize-contributing numerical values to create an anticipatory effect for the player. In particular, the final digit sets comprising the prize-contributing numerical values 133 and 282 are revealed by replacing a number at a central location in the respective initial digit set comprising row 616. Thus, up until the final value “9” at location 616/604 is replaced, it appears that the prize value may include the 7-digit value “1339282.” The second to last (“5” at location 619/606) and penultimate number (“4” at location 620/604) replaced in the example of FIGS. 5-11 are numbers adjacent to one of the prize-contributing numerical values. This sort of replacement at number locations adjacent to a prize-contributing numerical value, either between two such prize-contributing numerical values or preceding or following a prize-contributing numerical value may be performed at any point in the replacement process, but such removals at the end of the replacement process creates an anticipatory effect with the player hoping that certain digits will not be removed and therefor provide a larger prize value.

Where there are multiple prize-contributing numerical values included in the starting graphic, such as in the example of FIGS. 5-11 that includes five such prize-contributing numerical values, the individual prize-contributing numerical values are combined in some fashion to produce the prize value included in the award at 416 in FIG. 4. In some implementations, the different numerical values are summed to produce the prize value. The example of FIG. 11 shows that the prize-contributing numerical values 133, 282, 19, 47, and 269 are summed to produce the prize value of 750 credits shown in win meter window 507 and added to the credits at credit meter window 506. However, the invention is not limited to adding the prize-contributing numerical values. Alternative implementations may multiply the prize-contributing numerical values or combine the values in any or numerical operation or mixture of operations. For example, a prize-contributing numerical value appearing in a certain area of the array shown in FIG. 6 may operate as a multiplier while prize-contributing numerical values at other areas of the array are added together to form a value to which the multiplier is applied.

FIGS. 12 and 13 show an alternate implementation of the invention. The display 1200 shown in FIG. 12 is similar to that shown in FIG. 5, with a player information section 1202 and five wager controls 1210 below a display field 1204. Unlike the example of FIG. 5, display 1200 includes a graphic display area 1206 above field 1204, and also includes wagering control icons 1208 arranged in the field 1204. Each wagering control icon 1208 comprises a representation of a package and is associated with a wager value in credits. A player may select one of these wagering control icons 1208 in lieu of one of the wager controls 1210 to make an activation input at the gaming machine presenting the display 1200 (a gaming machine such as 100 in FIG. 1 for example). Display 1200 also shows a jackpot prize in a window 1212 included in the graphic display area 1206. This jackpot prize may comprise a progressive prize and may be available as a prize value presented in accordance with the invention or presented in some other fashion at the gaming machine, such as through a related game (bonus or base game).

FIG. 13 shows a display 1300 produced in response to a 40-credit bet representing an activation input at the gaming machine. The prize-contributing numerical values and non-contributing numerical values in this example are arranged in an array of number locations comprising nine rows and fifteen columns which covers the field 1204 and obscures most of the package icons. Non-contributing numerical values are replaced in the display 1300 in the same fashion as described above in connection with FIG. 4 and the example of FIGS. 5-11, to ultimately reveal/display one or more prize-contributing numerical values.

FIG. 14 comprises a block diagram of software and data structures that may be employed to implement prize value presentation arrangements in accordance with aspects of the present invention where the outcome for a given activation of the gaming machine is obtained first according to some random or pseudo-random process and then the display system is controlled to show the randomly selected outcome. The block diagram of FIG. 14 shows an arrangement 1402 for generating a first random number, an arrangement 1404 for obtaining an outcome based on that first random number, and an arrangement 1406 for generating a second random number. The outcome from 1404 is used to select an outcome script set 1408 corresponding to that outcome and the second random number from 1406 is used to select an outcome script for the given activation of the game. Game engine 1410 is operable to execute the selected outcome script to control the gaming machine display system to display the randomly selected outcome using media assets 1412 from an arrangement for storing such assets.

For centralized gaming architectures, a device such as a central determinant server (305 in FIG. 3 for example) may comprise the random number generating arrangement 1402. In such a centralized gaming architecture, the gaming machine may request a random number in response to an activation input (as shown at 404 in FIG. 4), and the central determinant server may include a random number generator which communicates the first random number to the gaming machine in response to the request. In many Class III type gaming systems, the random number generating arrangement 1402 comprises a random number generator at the gaming machine itself. In either case the random number generator may be a hardware-based random number generator or other random number generator conforming to applicable regulations for both security and randomness.

The arrangement 1404 for selecting an outcome based on the random number from block 1402 may likewise reside at a centralized device such as a central determinant server in a centralized gaming architecture or at the gaming machine itself. In either case the arrangement 1404 may select an outcome by using the first random number from 1402 to select from a pool of available outcomes to produce a desired prize distribution and payout percentage. Where the display of the prize value (as at 414 in FIG. 4) is implemented as a standalone game, the outcome will be the prize value to be displayed/revealed from the array of numbers (as shown in FIG. 6 for example). Where the display of the prize value in accordance with the present invention is only part of a prize that may be awarded for the activation of the gaming machine, such as where there is a base game and/or bonus games or features in addition to the prize value to be revealed in accordance with the present invention, the selected outcome has a possibility of including only the prize value to be displayed in accordance with the present invention (at 414 in FIG. 4) or both that prize value and an additional prize value to be shown for that other game portion. In some implementations, a prize value display arrangement in accordance with the present invention may be configured as a bonus game that is reached from some base game and the system is configured so that an activation of the base game may show a result that takes the system directly to the bonus game presentation without showing any prize awarded for the base game. In these implementations the prize value determined at 1404 may be the sole prize awarded for the activation of the gaming machine and may be presented in the prize value display arrangement in accordance with the present invention such as the example arrangement described in connection with FIGS. 5-11. The displays shown in FIGS. 12 and 13 may comprise such an implementation with the process immediately proceeding to the display 1300 of FIG. 13 in response to a bet placed while the gaming machine shows display 1200.

The second random number generating arrangement 1406 in the example of FIG. 14 comprises any suitable arrangement for generating a second random number. Where the gaming machine includes the arrangement 1402 for generating the first random number, the arrangement 1406 may comprise the same random number generator used to generate the first random number. Regardless of which specific element in the system is used to generate the second random number, that second random number is used in this example implementation of FIG. 14 together with the outcome selected at 1404 to select a specific outcome script to display the outcome at the gaming machine. Specifically, the gaming machine uses the outcome from 1404 to select an outcome script set 1408 that includes outcome scripts to show that particular outcome, that is, the prize associated with that outcome. The gaming machine also uses the second random number from block 1406 to select a specific one of the outcome scripts in the selected outcome script set 1408. For example, if the outcome correlates to a prize of 200 credits, the set 1408 containing scripts showing a 200-credit prize for the given activation of the gaming machine is selected and the second random number is used to select one of these scripts. As another example, if the outcome correlates to a prize of 500 credits, the set 1408 containing scripts showing a total 500-credit prize for the given activation of the gaming machine is selected and the second random number is used to select one of these scripts. The given script selected from a set 1408 may show only the prize value revealed in accordance with the invention as shown in FIGS. 5-11 for example, or that prize value and a value associated with another portion of the game for that gaming machine activation.

The specific script selected from the set 1408 for the prize to be awarded is then loaded to the game engine 1410 and executed to cause the display system to display the desired graphics. The game engine 1410 may, for example, include a JavaScript® Object Notation (JSON) script engine that receives the data from 1408 in JSON format and then interprets and executes the instructions contained in the received data. Of course, although the example shows a JSON script engine, the invention is certainly not limited to JSON or any other data interchange format or language. Regardless of the nature of game engine 1410, it may access media assets 1412 stored in the game software at the gaming machine or elsewhere in a networked system and use these media assets to cause the gaming machine display system to display the game outcome in accordance with the present invention. The media assets 1412 may include data structures for driving the various graphic elements shown in displays according to the present invention.

In other implementations of a prize revealing arrangement according to the present invention, the outcome script sets may not be stored as indicated at 1408 in FIG. 14 and selected with a second random number by the arrangement shown at 1406. In these implementations, control signals to cause the gaming machine display system to generate the displays for revealing the prize value in accordance with the present invention may be generated in response to the random outcome selected at the arrangement 1404 in FIG. 14 and communicated directly to the game engine (without operations as described above in connection with arrangement 1406 and script sets 1408). In particular, the outcome selected at 1404 may include a prize value to be displayed/revealed in accordance with the present invention and the display control commands for controlling the display device(s) to reveal that prize value built according to a suitable process.

Regardless of whether control scripts are generated ahead of time and stored as shown in FIG. 14, or whether they are generated “on-the-fly” in response to the outcome selected at 1404 in FIG. 14, the control for the display devices may be built by the same process. That process may include first obtaining the outcome in terms of the prize value to be displayed as indicated at 414 in FIG. 4 (and example display 1100 in FIG. 11). That prize value may be broken randomly into constituent values to be displayed as prize-contributing numerical values in accordance with the combination method to be applied (for example the values 133, 282, 19, 47, and 269 shown in FIG. 11). These prize-contributing numerical values may then be randomly placed into a blank digit array that will ultimately form the starting graphic. The placement will ensure that there is at least one blank space (number location) between prize-contributing numerical values. Once the prize-contributing numerical values are so placed in the blank array, non-contributing numerical values may be randomly selected for the remaining number locations in the array. Preferably, the first few non-contributing numerical values are placed adjacent or in between prize-contributing numerical values and the order of placement is stored. This order of placement is then used in reverse to replace the non-contributing numerical values to provide the anticipation effect described above in connection with the example of FIGS. 9-11.

Variations on this process for producing display control signals for implementing prize presentations in accordance with the present invention may include breaking the overall prize value into the prize-contributing numerical values as part of the outcome generation process at 1404 in FIG. 14. Also, implementations of the invention may use a virtual or physical set of reels or other rotating elements to determine a random outcome for the game and then a prize defined by that outcome may be presented through a prize presentation according to the present invention (such as that shown in FIGS. 5-11 for example). Numerous other variations are possible, including employing the random selection to fill the number location array to determine the prize value to be displayed for the given activation of the gaming machine.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above-described preferred embodiments are intended to illustrate the principles of the invention, but not to limit the scope of the invention. Various other embodiments and modifications to these preferred embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A method of controlling a gaming machine, the method including:
(a) for an activation of the gaming machine, causing a display system of the gaming machine to display a starting graphic, the starting graphic including one or more prize-contributing numerical values and, for at least one of the one or more prize-contributing numerical values, one or more non-contributing numerical values preceding or following the respective prize-contributing numerical value;
(b) after the display of the starting graphic, causing the display system to display a replacement of each of the non-contributing numerical values with a respective non-numerical graphic to reveal at the display system the one or more prize-contributing numerical values; and
(c) awarding a prize for the activation of the gaming machine, the prize including a prize value defined by (i) a combination of the prize-contributing numerical values where more than one prize-contributing numerical value is included in the starting graphic or, where only one prize-contributing numerical value is included in the starting graphic, by (ii) the one prize-contributing numerical value.

2. The method of claim 1 wherein the starting graphic includes more than one prize-contributing numerical value and the prize value is equal to the sum of the prize-contributing numerical values.

3. The method of claim 1 wherein the starting graphic includes more than one prize-contributing numerical value and the prize value is equal to the product of the prize-contributing numerical values.

4. The method of claim 1 wherein:
(a) the starting graphic includes more than three non-contributing numerical values; and
(b) displaying the replacement of the non-contributing numerical values is performed at a rate which declines from an initial rate.

5. The method of claim 1 wherein:
(a) the starting graphic includes more than three non-contributing numerical values; and
(b) displaying the replacement of the non-contributing numerical values includes displaying the replacement of at least two of the non-contributing numerical values substantially simultaneously.

6. The method of claim 1 wherein:
(a) the starting graphic includes more than three non-contributing numerical values which are replaced in a replacement sequence; and
(b) only a single respective non-contributing numerical value is replaced at each respective time in the replacement sequence.

7. The method of claim 1 wherein:
(a) the starting graphic includes a group of initial digit sets, each initial digit set including a respective number at each of a plurality of respective number locations in horizontal alignment and the initial digit sets together defining an initial digit field; and
(b) causing the display system to display the replacement of each non-contributing numerical value with the respective non-numerical graphic includes causing the display system to display the replacement of the respective number at the respective number location in the respective initial digit set with a respective non-numerical location graphic such that after each non-contributing numerical value is replaced, the display system displays one or more final digit sets, each final digit set defining a respective one of the prize-contributing numerical values and comprising a sequence of one or more of the number locations each containing the respective number included at that number location in the initial digit field.

8. The method of claim 7 wherein the display system displays at least a first final digit set and a second final digit set and where at least one of the respective numbers replaced to produce the first final digit set and second final digit set is replaced at a central number location in a respective initial digit set to divide the numbers remaining from that respective initial digit set into the first final digit set and the second final digit set.

9. The method of claim 7 wherein a final one of the numbers replaced to produce the one or more final digit sets is replaced at a central number location in a respective initial digit set to divide the set of numbers remaining from that respective initial digit set into two different digit sets each comprising one of the final digit sets.

10. A gaming machine including:
(a) a display system;
(b) a player input system;
(c) at least one processor; and
(d) at least one memory device storing instructions executable by the at least one processor to:
(i) for an activation of the gaming machine responsive to a player input received at the player input system, cause the display system to display a starting graphic, the starting graphic including one or more prize-contributing numerical values and, for at least one of the one or more prize-contributing numerical values, one or more non-contributing numerical values preceding or following the respective prize-contributing numerical value;
(ii) after the display of the starting graphic, cause the display system to display a replacement of each of the non-contributing numerical values with a respective non-numerical graphic to reveal at the display system the one or more prize-contributing numerical values; and
(iii) award a prize for the activation of the gaming machine, the prize including a prize value defined by a combination of the prize-contributing numerical values where more than one prize-contributing numerical value is included in the starting graphic or, where only one prize-contributing numerical value is included in the starting graphic, by the one prize-contributing numerical value.

11. The gaming machine of claim 10 wherein the starting graphic includes more than one prize-contributing numerical value and the prize value is equal to the sum of the prize-contributing numerical values.

12. The gaming machine of claim 10 wherein the starting graphic includes more than one prize-contributing numerical value and the prize value is equal to the product of the prize-contributing numerical values.

13. The gaming machine of claim 10 wherein:
(a) the starting graphic includes more than three non-contributing numerical values; and
(b) displaying the replacement of the non-contributing numerical values is performed at a rate which declines from an initial rate.

14. The gaming machine of claim 10 wherein:
(a) the starting graphic includes more than three non-contributing numerical values; and
(b) displaying the replacement of the non-contributing numerical values includes displaying the replacement of at least two of the non-contributing numerical values substantially simultaneously.

15. The gaming machine of claim 10 wherein:
(a) the starting graphic includes more than three non-contributing numerical values which are replaced in a replacement sequence; and
(b) only a single respective non-contributing numerical value is replaced at each respective time in the replacement sequence.

16. The gaming machine of claim 10 wherein:
(a) the starting graphic includes a group of initial digit sets, each initial digit set including a respective number at each of a plurality of respective number locations and the initial digit sets together defining an initial digit field; and
(b) causing the display system to display the replacement of each non-contributing numerical value with the respective non-numerical graphic includes causing the display system to display the replacement of the respective number at the respective number location in the respective initial digit set with a respective non-numerical location graphic such that after each non-contributing numerical value is replaced, the display system displays one or more final digit sets, each final digit set defining a respective one of the prize-contributing numerical values and comprising a sequence of one or more of the number locations each containing the respective number included at that number location in the initial digit field.

17. The gaming machine of claim 16 wherein the display system displays at least a first final digit set and a second final digit set and where at least one of the respective numbers replaced to produce the first final digit set and second final digit set is replaced at a central number location in a respective initial digit set to divide the numbers remaining from that respective initial digit set into the first final digit set and the second final digit set.

18. The gaming machine of claim 16 wherein a final one of the numbers replaced to produce the one or more final digit sets is replaced at a central number location in a respective initial digit set to divide the set of numbers remaining from that respective initial digit set into two different digit sets each comprising one of the final digit sets.

19. A program product comprising one or more non-transitory computer readable data storage devices storing program code for a gaming machine, the program code including:
(a) starting graphic program code executable by at least one processor to, for an activation of the gaming machine, cause a display system of the gaming machine to display a starting graphic, the starting graphic including one or more prize-contributing numerical values and, for at least one of the one or more prize-contributing numerical values, one or more non-contributing numerical values preceding or following the respective prize-contributing numerical value;
(b) replacement program code executable by the at least one processor to cause the display system of the gaming machine to, after the display of the starting graphic, display a replacement of each respective non-contributing numerical value with a respective non-numerical graphic to reveal at the display system the one or more prize-contributing numerical values; and
(c) prize assignment program code executable by the at least one processor to award a prize for the activation of the gaming machine, the prize including a prize value defined by (i) a combination of the prize-contributing numerical values where more than one prize-contributing numerical value is included in the starting graphic or, where only one prize-contributing numerical value is included in the starting graphic, by (ii) the one prize-contributing numerical value.

20. The program product of claim 19 wherein:
(a) the starting graphic includes a group of initial digit sets, each initial digit set including a respective number at each of a plurality of respective number locations in horizontal alignment and the initial digit sets together defining an initial digit field; and
(b) the replacement program code is executable to cause the display system to display the replacement of each non-contributing numerical value with the respective non-numerical graphic by causing the display system to display the replacement of the respective number at the respective number location in the respective initial digit set with a respective non-numerical location graphic such that after each non-contributing numerical value is replaced, the display system displays one or more final digit sets, each final digit set defining a respective one of the prize-contributing numerical values and comprising a sequence of one or more of the number locations each containing the respective number included at that number location in the initial digit field.
